(19) United States
(12) Patent Application Publication
(10) Pub. No.: US 2003/0034075 A1
(43) Pub. Date: Feb. 20, 2003

(54) Electromagnetic HVAC valve

(76) Inventors: Mark W. Stevenson, Appleton, NY (US); Gerald M. Goupil JR., N. Tonawanda, NY (US)

Correspondence Address: PATRICK M. GRIFFIN, DELPHI TECHNOLOGIES, INC., Legal Staff Mail Code: 480-414-420, P.O. Box 5052, Troy, MI, 48007-5052, US

(21) Appl. No.: 09/932,340

(22) Filed: Aug. 17, 2001

(51) Int. Cl. F16K 11/072

(52) U.S. Cl. 137/625.22

(57) ABSTRACT

An electromagnetic ventilation valve includes a fixed member defining at least a first aperture therethrough. A movable member having at least one magnetically reactive element positioned thereon is juxtaposed next to the fixed member. The movable member further defines at least a second aperture therethrough and is translatable between at least an opened and a closed position. The opened position corresponds to the first and second apertures substantially in full registration one with the other and defining an air passage therethrough. The closed position corresponds to the first and second apertures in non-registration to close the air passage. At least one electromagnet is located proximate to the magnetically reactive element such that activation of the electromagnet causes the movable member to translate between the opened and closed positions.

### TECHNICAL FIELD

The above-referenced invention relates to vehicle heating, ventilation and air conditioning systems, and more specifically to ventilation valves controlling airflow within a vehicle HVAC system.

### BACKGROUND OF THE INVENTION

Vehicle ventilation systems have long been utilized in vehicles to provide comfort to the vehicle occupants. Initial ventilation systems comprised the simple duct that was opened or closed by a manually operated valve directing outside ambient air to the vehicle interior. Through the years, consumers have desired increased interior comfort and manufacturers have delivered systems to satisfy consumer demand for improved interior temperature control. Advances made over the years include directing air over a heated core for delivering hot air to the vehicle interior and also for delivering hot air to the windshield to keep the windshield clear of frost and moisture. Subsequently, air conditioners have also become commonplace accessories in vehicles to provide cool air for the comfort of passengers in summer's heat.

Heating ventilation and air conditioning systems in today's vehicles now provide total interior climate control. These new systems automatically maintain a desired temperature by delivering an appropriate mix of heated, ambient, and cooled air to the vehicle interior. More advanced systems also permit occupants to select a desired temperature for their individual zones and automatically maintain these zones at the pre-selected temperature. Such operation necessarily requires the automatic operation of multiple valves and ducts to achieve the desired operation of the vehicle heating, ventilation and air conditioning system.

While the sophistication and complexity of heating ventilation and air conditioning (HVAC) systems for vehicles has steadily increased, the design of valves utilized in HVAC systems has remained relatively unchanged throughout the years. Vehicle HVAC modules now include a number of separate valves that have been automated through the use of various types of actuators either directly connected to the valve or with mechanical linkages such as gears, push rods, or mechanical arms. Typically, these valves are hinged doors and activation of the actuator causes the valve door to rotate about the hinge between an opened and closed position. This type of valve design necessarily requires that the valve door repeatedly engages and disengages from contact with the duct or housing to which it is affixed. Consequently, these valves require space for unimpeded rotation of the door about the hinge. System space in a vehicle is now at a premium with an ever-increasing demand to reduce the volume required for individual systems. Additionally, the valves and actuators, and the necessary linkage therebetween, must be independently assembled to the HVAC system and thus become labor intensive in an era where labor is increasingly expensive and thus desirable to minimize. Furthermore, ventilation valves incorporating hinged doors and mechanical linkages produce objectionable noises to the vehicle occupants such as foam crush, squeaks, rattles, motor wind, gear lash, etc. Such noises tend to detract and annoy the occupants as well as fostering a perception of decreased quality.

Thus, there is a need for a ventilation valve for use in vehicle heating ventilation and air conditioning systems that is cost efficient, quiet, and requires a minimum volume for operation.

### SUMMARY OF THE INVENTION

In one aspect, the present invention includes an electromagnetic ventilation valve including a fixed member defining at least a first aperture therethrough. A movable member having at least one magnetically reactive element positioned thereon is juxtaposed next to the fixed member. The movable member further defines at least a second aperture therethrough and is translatable between at least an opened and a closed position. The opened position corresponds to the first and second apertures substantially in full registration one with the other and defining an air passage therethrough. The closed position corresponds to the first and second apertures in non-registration to close the air passage. At least one electromagnet is located proximate to the magnetically reactive element such that activation of the electromagnet causes the movable member to translate between the opened and closed positions.

In another aspect of the present invention, an electromagnetic ventilation valve for an automobile heating, ventilation and air conditioning system includes a first conical member having a plurality of apertures therethrough and a second conical member in coaxial juxtaposition thereto. The second conical member is axially rotatable with respect to the first conical member. A magnetically reactive element is affixed to the second conical member and a stationary electromagnet is positioned in magnetic proximity to the magnetically reactive element wherein when the electromagnet is energized the magnetically reactive element magnetically interacts with the electromagnet.

These and other features and advantages of the present invention will be further understood and appreciated by those skilled in the art by reference to the following specification, claims, and appended drawings.

### BRIEF DESCRIPTION OF THE DRAWINGS

FIG. 1 is a block diagram of an electromagnetic valve embodying the present invention.

FIG. 2 is a block diagram of an alternate embodiment of the electromagnetic valve shown in FIG. 1.

FIG. 3 is an elevational cross-section of the fixed and movable plates of the electromagnetic valve shown in FIG. 1.

FIG. 4 is an elevational cross-section of a typical heating, ventilation and control module illustrating the airflow therethrough and the positioning of valves therein.

FIG. 5 is a conceptual illustration of a rotary valve embodying the present invention.

FIG. 6 is an elevational view of a conical electromagnetic valve showing the valve mounted in a duct shown in cross-section.

FIG. 7 is a top view of the conical valve illustrated in FIG. 6.

FIG. 8 is a partial cross-section of the conical valve of FIG. 6 taken along the Line 8-8.

### DESCRIPTION OF THE PREFERRED EMBODIMENT

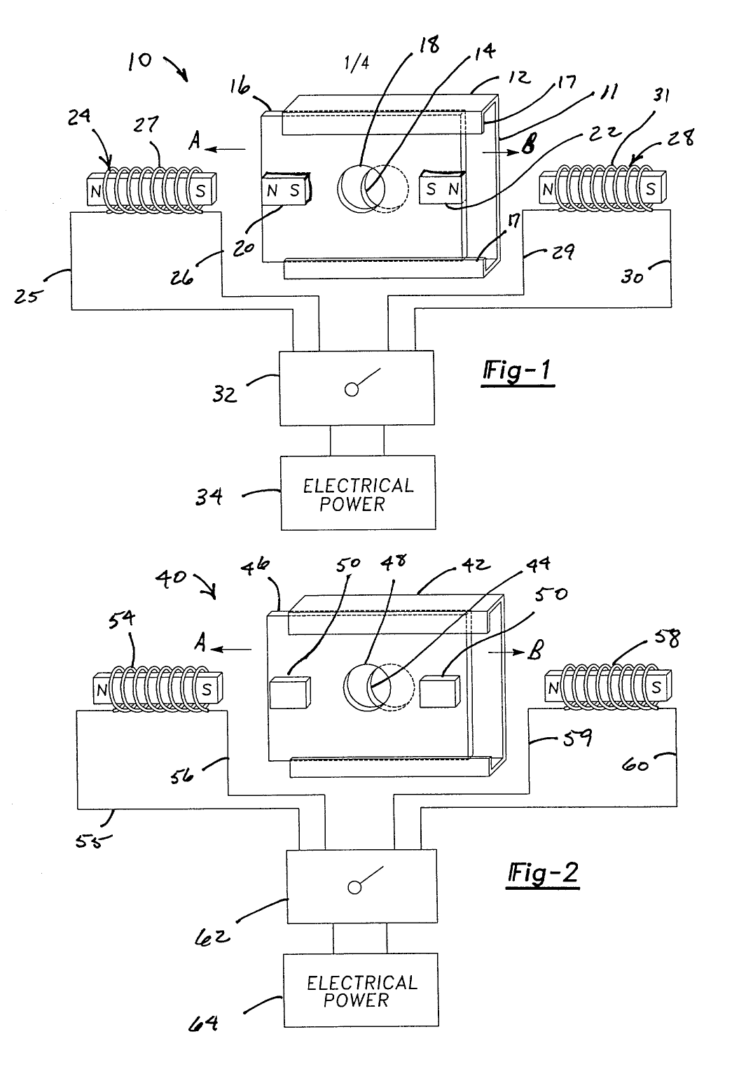

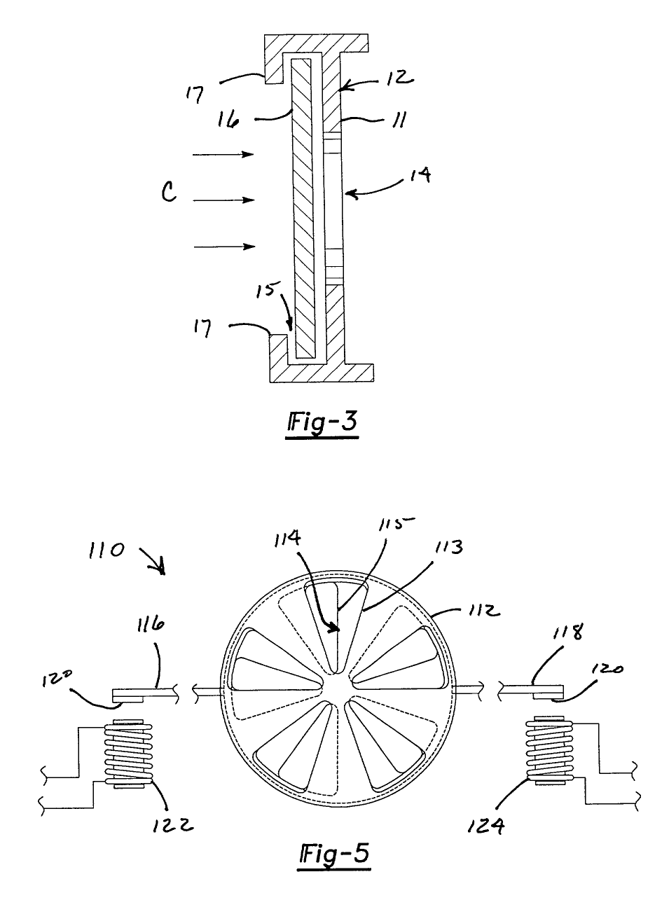

An electromagnetic valve 10 (FIG. 1) embodying the present invention is adapted to open and close an air passageway in a vehicle heating, ventilation, and air conditioning system. The valve 10 is shown conceptually in FIGS. 1 and 3 and includes a fixed member 12 having an aperture 14 therethrough for allowing the passage of air. Fixed member 12 has a generally C-shaped cross-section wherein upper and lower lips 17 define a lateral slot 15. A movable member 16 is received in slot 15 and is juxtaposed to rear wall 11 of fixed member 12. Movable member 16 is laterally translatable within slot 15 to the left as indicated by arrow “A” and to the right as indicated by arrow “B”. Movable member 16 further includes an aperture 18 therethrough wherein aperture 18 can be selectively aligned or misaligned with aperture 14 with the lateral translation of movable member 16 with respect to fixed member 12. Movable member 16 also includes a first fixed polarity magnet 20 at its left edge and a second fixed polarity magnet 22 at its right edge. Magnets 20 and 22 are arranged such that one of the magnet poles is most proximate to its respective edge of movable member 16 and the opposite pole is oriented toward aperture 18. The specific pole orientations will be discussed in greater detail below.

A left electromagnet 24 is positioned in lateral alignment with magnet 20 such that when movable member 16 is translated in direction “A” and magnet 20 contacts electromagnet 24, aperture 18 is shifted to the left and misaligned with aperture 14 such that there is no overlap of aperture 18 with aperture 14. Electromagnet 24 has a first electrical lead 25 connected to one end of winding 27 and a second electrical lead 26 connected to an opposite end of winding 27. Electrical leads 25 and 26 in turn are connected to switch 32. A right electromagnet 28 is positioned to the right of movable member 16 and laterally spaced therefrom such than when movable member 16 is translated to the right such that magnet 22 contacts electromagnet 28 apertures 14 and 18 are in substantial alignment to permit the flow of air therethrough. Electrical lead 29 is connected to a first end of winding 31 and electrical lead 30 is connected to an opposite end of winding 31. Electrical leads 29 and 30 are in turn also connected to switch 32. An electrical power source 34 is also connected to switch 32.

As shown in FIG. 1, vent 10 is configured to induce translation of movable member 16 in direction “A”. Magnets 20 and 22 are oriented such that the north poles are most proximate to the edges of movable member 16, and the south poles of magnets 20 and 22 are oriented toward aperture 18. Switch 32 has at least three positions wherein at least one of the three positions is an “off” position wherein electrical power is disconnected from both electromagnets. Those skilled in the art will understand that changing the polarity of the electrical power applied to electromagnets 24 and 28 will correspondingly change the magnetic polarity of the electromagnets. In the configuration as shown in FIG. 1, electrical leads 25 and 29 are tied together, and electrical leads 26 and 30 are tied together such that when power is applied to vent 10 both electromagnets are simultaneously energized and the polarity of the electromagnets are the same, the north poles are on the left side of the electromagnets and the south poles are on the right sides of the electromagnets. In this manner, the south pole of left electromagnet 28 attracts the north pole of fixed polarity magnet 20 on movable member 16 and the north pole of right electromagnet 28 repels the north pole of fixed polarity magnet 22 on movable member 16. In this manner, movable member 16 is translated to the left until fixed polarity magnet 20 contacts the core of electromagnet 24 thus translating aperture 18 out of alignment with aperture 14 and placing valve 10 in a “closed” state blocking airflow. Once the “closed” state has been achieved switch 32 can be selected to the “off” position removing electrical power from electromagnets 24 and 28 to conserve electric power. Movable member 16 is maintained in its most leftward position by the north pole of fixed polarity magnet 20 continuing to be magnetically attracted to the core of electromagnet 24.

When valve 10 is desired to be placed in an “opened” state wherein movable member 16 is translated in direction “B” to align apertures 14 and 18, switch 32 is energized to apply opposite polarity electrical power to electromagnets 24 and 28. Thus, electromagnets 24 and 28 then have their south poles on the left side of the magnet and their north poles on the right side of the magnet. In this manner, the north pole of fixed polarity magnet 20 which is in contact with the core of electromagnet 24 is thus repelled by the north pole of electromagnet 24 to induce a force on movable member 16 in direction “B”. Likewise, electromagnet 28 now has its south pole on the left side of the magnet which in turn attracts the north pole of fixed polarity magnet 22 on the right side of movable member 16 thereby increasing the force applied to movable member 16 in direction “B”. Movable member 16 thus translates to the right until the north pole of fixed polarity magnet 22 contacts the electromagnet 28 aligning apertures 14 and 18 to permit airflow therethrough. Valve 10 is maintained in this “opened” state by the north pole of fixed polarity magnet 22 being magnetically attracted to the core of electromagnet 28 until such time as the electromagnets 24 and 28 are again energized in the opposite polarity to translate movable member 16 to its “closed” state. Those skilled in the art will understand that alternate magnetic polarity arrangements are possible as long as the simultaneous energizing of electromagnets 24 and 28 cause a repelling force on one side of movable member 16 and an attractive force on the opposite side of movable member 16. Additionally, those skilled in the art will also recognize that the physical configuration of fixed member 12 and movable member 16 can be altered for adaptation to specific applications without departing from the scope of the invention.

Turning now to FIG. 2, an electromagnetic valve 40 is shown which is a variation of the valve 10 discussed above. In this embodiment, valve 40 includes a fixed member 42 having an aperture 44 therethrough, and a movable member 46 that is laterally translatable with respect to fixed member 42. Movable member 46 also includes an aperture 48 wherein lateral translation of movable member 46 causes aperture 48 to be alternately aligned and misaligned with aperture 44 to place valve 40 in respective “opened” and “closed” states. As with valve 10, translation of movable member 46 in direction “A” places valve 40 in a “closed” state and translation of movable member 46 in direction “B” places valve 40 in an “opened” state. Movable member 46 includes magnetically reactive elements at the left and right edges thereof, however, magnetically reactive elements 50 are not magnets but are of a material that is attracted by a magnet such as iron or steel. Valve 40 includes left electromagnet 54 positioned to the left of movable member 46 such that when the left element 50 contacts electromagnet 54 valve 40 is in its “closed” state. Likewise, right electromagnet 58 is positioned to the right of movable member 46 such that when the right element 50 contacts electromagnet 58 apertures 48 and 44 are aligned placing valve 40 in its “opened” state. Electromagnet 54 has electrical leads 55 and 56 connected to switch 62 and electromagnet 58 has electrical leads 59 and 60 also connected to switch 62. An electrical power source 64 is also connected to switch 62. Switch 62 is again a three-position switch with one of the switch positions being an “off” position where electrical power is not applied to either electromagnet 54 or electromagnet 58, and each electromagnet is connected to a separate switch position.

In operation, when valve 40 is desired to be placed in its “closed” state, switch 62 is correspondingly positioned to apply electrical power to electromagnet 54. Electromagnet 58 is maintained in a non-energized state. When energized, electromagnet 54 creates a magnetic field which attracts the magnetically reactive element 50 on the left side of movable member 46 thus translating movable member 46 to the left until the element 50 contacts electromagnet 54. Switch 62 is then placed in its off position wherein electrical power is isolated from both electromagnets 54 and 58. Those skilled in the art will readily understand that the polarity of electromagnets 54 and 58 wherein energized are not critical since either the north pole or the south pole will attract magnetically reactive elements 50.

Movable member 46 is located on the “upstream” side of the airflow and is thus maintained in its closed position by the upstream air impinging upon member 46 and forcing member 46 in frictional contact with fixed member 42. This can be visualized by again looking at FIG. 3 wherein the upstream airflow designated by arrows “C” impinge upon movable member 16 thereby forcing it against wall 11 of fixed member 12.

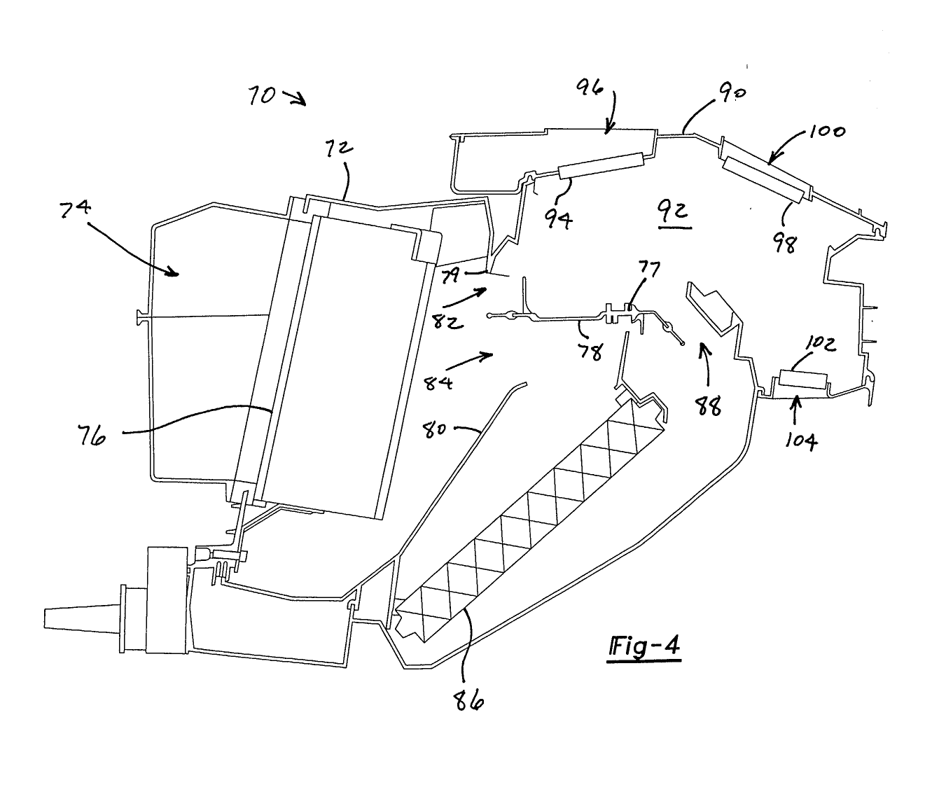

Turning now to FIG. 4, a typical heating, ventilation, and air conditioning unit utilized in a vehicle is shown generally at 70 wherein unit 70 is comprised of core module 72 and air distribution module 90. Ambient outside air or recirculated interior air is directed to air inlet 74 and is drawn across air conditioning cooling core 76. After the air exits from cooling core 76 to pass between point 79 and wall 80, part of the air is directed through cool air inlet area 82 and part of the air is directed to warm air passage 84. Inlet 82 and passage 84 are variable in area depending upon the position of diverter valve 78. Diverter valve 78 is hinged at 77 to pivot therearound and the position of diverter valve 78 is directly related to the desired air temperature of air to be output into the interior of the vehicle. Thus, to obtain the maximum amount of cool air diverter valve 78 is rotated counter-clockwise to maximize the area of cool air inlet 82. If heated air is desired, diverter valve 78 is rotated clockwise to create a warm air passage 84 thereby diverting a portion of the airflow exiting from cooling core 76 to flow across heater core 86 and duct the heated air through heated air inlet 88. An intermediate position of diverter valve 78 facilitates a mixture of cool and hot air entering air chamber 92 simultaneously to provide air at a desired temperature.

Air chamber 92 typically has three designated outlets for delivering the conditioned air to different portions of the vehicle. These outlets are generally referred to as a defrost outlet 96 for delivering air to the interior surface of the windshield, the vent outlet 100 for delivering air to the upper portion of the vehicle interior, and a heater outlet 104 for delivering air to the floor area of the vehicle interior. Electromagnetic valves also permit the optimization of air chamber 92 configuration to facilitate proper air mixing and airflow. FIG. 4 illustrates incorporation of the electromagnetic valves as defrost valve 94, ventilator valve 98, and heater valve 102. Depending upon the desired or intended use of the conditioned air to be output from the HVAC system, only one or two of the desired outputs are necessary to provide the desired function such as defrost only, defrost and heater, or heater and vent outlets (also known as “bi-level”). In order to select the different outlet configurations, valves must be provided at these outlets to selectively open and close the air passages therethrough. In previous configurations, these valves were typically hinged at one end and required a significant amount of interior volume within air chamber 92 for proper operation. The incorporation of an electromagnetic valve, such as valve 10 or valve 40 as described above, eliminates the need for a large air chamber 92 to accommodate the pivoting room of a prior art valve and thus contributes to the size minimization of air chamber 92.

Referring now to FIG. 5, a rotary electromagnetic valve 110 is shown. Rotary valve 110 includes a fixed disc 112 having a plurality of pie-shaped apertures 113 therethrough. A rotating disc 114 is juxtaposed to fixed disc 112 and includes a like plurality of pie-shaped apertures 115. Rotatable disc 114 can be rotated between an open position wherein apertures 113 and 115 are in total alignment to a closed position wherein apertures 113 and 115 are in total non-alignment. Disk 114 when placed in an intermediate position permits partial airflow therethrough. Rotatable disc 114 includes left actuating arm 116 and right actuating arm 118 affixed thereto and terminates with magnetic reactive elements 120. Stationary left electromagnet 122 and right electromagnet 124 are positioned in magnetic proximity to magnetically reactive elements 120 such that energizing electromagnet 122 induces a counter-clockwise rotation of rotatable member 114 to close vent 110 and energizing electromagnet 124 likewise attracts magnetically reactive element 120 on arm 118 to rotate member 114 in a clockwise direction to open vent 110. Those skilled in the art will readily recognize that valve 110 can be functionally configured to operate in a manner similar to valve 40 as discussed above wherein electromagnets 122 and 124 are alternately energized to induce the desired rotation of member 114. Alternately, magnetically reactive elements 120 can be configured as fixed polarity magnets and electromagnets 122 and 124 are energized simultaneously with alternating polarities in a manner similar to valve 10 as described above.

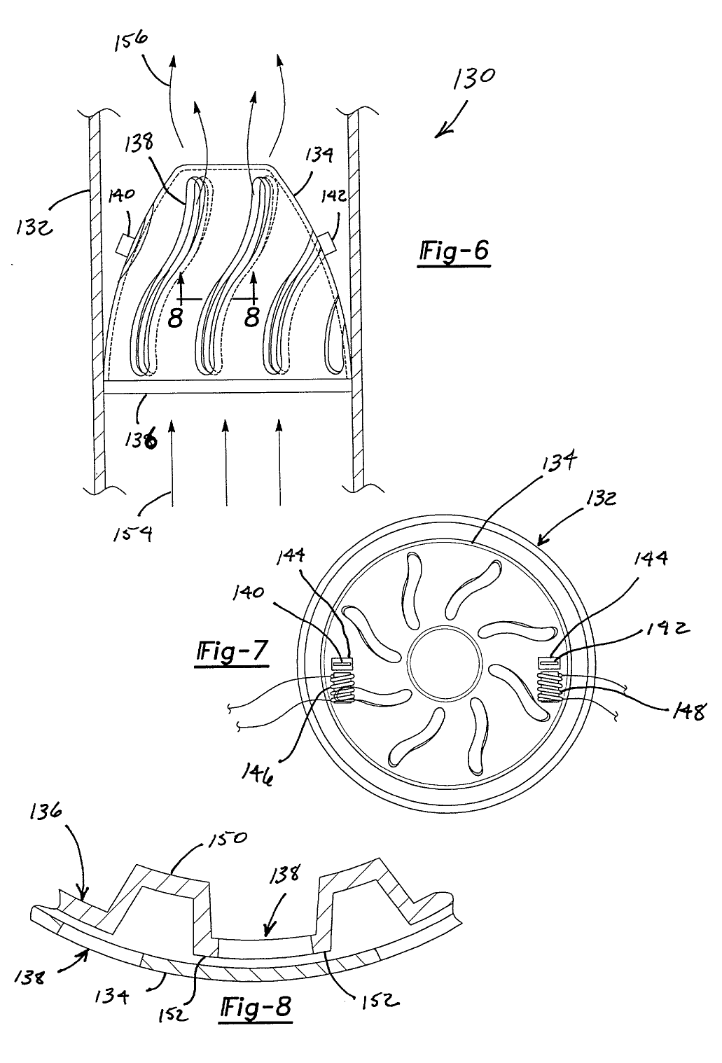

Referring now to FIGS. 6-8, a conical electromagnetic valve 130 is shown installed in a duct 132. Conical valve 130 includes a fixed cone 134 which is affixed in duct 132 in a stationary manner and further has a rotatable cone 136 juxtaposed to an interior of fixed cone 134 in a nested manner. Each of cones 134 and 136 include matching helical slots 138, which through rotation of rotatable cone 136 are either in full, partial, or nonalignment. Rotatable cone 136 also includes left and right tabs 140 and 142, respectively, wherein tabs 140 and 142 comprise a magnetically reactive material and can either extend through slots 144 in fixed cone 134 as shown or alternately may extend to an interior of rotatable cone 136. Left and right electromagnets 146 and 148 are positioned in magnetic proximity to tabs 140 and 142 in a manner similar to rotary valve 110 as discussed above. Again, tabs 140 and 142 can be a material which is magnetically attracted when electromagnets 146 and 148 are alternately energized to induce the desired rotation of rotatable cone 136 in a manner similar to the concept illustrated in valve 40 above. Alternatively, according to the concept of valve 10 as discussed above, tabs 140 and 142 can be fixed polarity magnets wherein electromagnets 146 and 148 are simultaneously energized in a first polarity to induce member 136 to rotate in one direction, and then energized in an opposite polarity to induce an opposite rotation of cone 136. Airflow 154 entering valve 130 may not be completely mixed and may actually comprise a cool air layer and a warm air layer. It is desirable to have such a layered flow mixed to have a uniform temperature. The flow of air through helical slots 138 will induce rotation to the airflow as conceptualized by arrows 156 thus mixing the air into a substantially uniform temperature airflow. The conical configuration of valve 130 results in a large area contact between cones 134 and 136. Since the frictional force therebetween is a function of the contact area, the force required to rotate cone 136 with respect to cone 134 can be significant.

FIG. 8 illustrates a partial cross-section of the walls of cones 134 and 136 wherein rotatable cone 136 includes a plurality of ribs. Thus, the configuration of cone 136 has a wall which undulates in a serpentine fashion having portion which is in contact with the interior of cone 134 and adjacent portions thereof that extend away from the wall of cone 134 toward the interior of cone 136. If slots 138 in cone 136 are formed in those areas of contact with the interior of cone 134, the actual area of contact between cone 136 and 134 is significantly reduced as illustrated by contact area 152 of cone 136. By minimizing the contact area between cones 134 and 136, the frictional resistance of rotating cone 136 with respect to 134 is also minimized thereby minimizing the electrical power usage and size of electromagnets 146 and 148.

In the foregoing descriptions, those skilled in the art will readily appreciate that modifications may be made to the invention without departing from the concepts disclosed herein. Such modifications are to be considered as included in the following claims, unless these claims by their language expressly state otherwise.

1. An electromagnetic ventilation valve comprising:
a fixed member defining at least a first aperture therethrough;
a movable member in juxtaposition with said fixed member and including a magnetically reactive element thereon, said movable member further defining at least a second aperture therethrough, said movable member translatable between at least an open and a closed position wherein said open position corresponds to said at least first aperture and said at least second aperture substantially in full registration one with the other defining an air passage therethrough and wherein said closed position corresponds to said at least first aperture and said at least second aperture in non-registration to close said air passage;
at least one electromagnet proximate to said magnetically reactive element such that activation of said electromagnet causes said movable member to translate between said open and said closed positions.

2. An electromagnetic ventilation valve according to claim 1 further including:
two magnetically reactive elements on said movable member; and
two electromagnets wherein a first of said electromagnets when energized attracts a first of said magnetically reactive elements to translate said movable member to said open position, and wherein a second of said electromagnets when energized attracts a second of said magnetically reactive elements to translate said movable member to said closed position.

3. An electromagnetic ventilation valve according to claim 2 further including:
an intermediate electromagnet; and
an intermediate magnetically reactive element positioned between said first and said second magnetically reactive elements wherein said intermediate electromagnet when energized translates said movable member to an intermediate airflow position such that said first and said second apertures are in partial registration.

4. An electromagnetic ventilation valve according to claim 1 wherein:
said at least one magnetically reactive element is a fixed polarity magnet; and
said electromagnet is switchable between opposite polarities to alternately attract and repel said fixed polarity magnet for translation of said movable member.

5. An electromagnetic ventilation valve according to claim 4 comprising:
first and second fixed polarity magnets on said movable member; and
a first stationary electromagnet proximate to said first fixed polarity magnet and a second stationary electromagnet proximate to said second fixed polarity magnet wherein said first fixed polarity magnet is in magnetic proximity to said first electromagnet when said valve is in said open position and said second fixed polarity magnet is in magnetic proximity to said second electromagnet when said valve is in said closed position.

6. An electromagnetic ventilation valve according to claim 5 wherein:
said first and said second fixed polarity magnets are oriented in a same polarity; and
said first and said second stationary electromagnets are configured to simultaneously energize in opposite polarities.

7. An electromagnetic ventilation valve according to claim 5 wherein:
said first and said second fixed polarity magnets are oriented in opposing polarities; and
said first and said second stationary electromagnets are configured to simultaneously energize in same polarities.

8. An electromagnetic ventilation valve according to claim 5 further including a switch in electrical communication with said first and said second electromagnets for selectively energizing and de-energizing said electromagnets.

9. An electromagnetic ventilation valve according to claim 1 wherein:
said fixed member is configured as a cone; and
said movable member is configured as a cone, said movable member rotatable within said fixed member.

10. An electromagnetic ventilation valve according to claim 9 wherein said fixed member and said movable member each define a plurality of like positioned apertures therethrough.

11. An electromagnetic ventilation valve according to claim 10 wherein said apertures are slots.

12. An electromagnetic ventilation valve according to claim 11 wherein said slots are arranged about a periphery of said cones in a helical fashion.

13. An electromagnetic ventilation valve for an automobile heating, ventilation, and air conditioning system, said ventilation valve comprising:
a first conical member having a plurality of apertures therethrough;
a second conical member in coaxial juxtaposition with said first conical member, said second conical member axially rotatable with respect to said first conical member;
a magnetically reactive element affixed to said second conical member; and
a stationary electromagnet in magnetic proximity to said magnetically reactive element wherein when said electromagnet is energized said magnetically reactive element magnetically interacts with said electromagnet.

14. An electromagnetic ventilation valve according to claim 13 wherein a surface of said second conical member includes a plurality of ribs.

15. An electromagnetic ventilation valve according to claim 14 wherein alternate ones of said ribs contact a surface of said first conical member to minimize friction between said first conical member and said second conical member.

16. An electromagnetic ventilation valve according to claim 15 wherein said ribs contacting said first conical member define said plurality of apertures in said second conical member.

17. An electromagnetic ventilation valve according to claim 16 wherein said magnetically reactive element is a fixed polarization magnet.

18. An electromagnetic ventilation valve according to claim 17 including:
two fixed polarized magnets; and
two stationary electromagnets, each of said electromagnets in magnetic proximity to a different one of said fixed polarized magnets.
